(19) United States
(12) Patent Application Publication
(10) Pub. No.: US 2017/0291388 A1
(43) Pub. Date: Oct. 12, 2017

(54) LIGHT WEIGHT COMPONENT WITH INTERNAL REINFORCEMENT AND METHOD OF MAKING

(71) Applicant: UNITED TECHNOLOGIES CORPORATION, Farmington, CT (US)

(72) Inventor: Gary D. Roberge, Tolland, CT (US)

(21) Appl. No.: 15/096,653

(22) Filed: Apr. 12, 2016

(51) Int. Cl. B32B 5/18

(52) U.S. Cl. CPC B32B 5/18; B32B 2266/045

(57) ABSTRACT

A method of making a light weight component is provided. The method including the steps of: forming a first metallic foam core into a desired configuration; applying an external metallic shell to a discrete exterior surface of the first metallic foam core after it has been formed into the desired configuration; arranging the first metallic form core to be adjacent to a second metallic foam core also formed into a desired configuration to form a desired pre-form shape, wherein an applied external metallic shell located on a discrete surface of the second metallic foam core is adjacent to the external metallic shell applied to the discrete exterior surface of the first metallic foam core; and applying an external metallic shell to an exterior surface of the desired pre-form shape.

### BACKGROUND

This disclosure relates generally to methods of making low-cost, light weight components and components formed by the aforementioned methods. In particular, the present application is directed to a component formed from a composite of metallic foam and an external metallic shell. In addition, various embodiments of the present disclosure are also directed to methods for making such a component.

Commercially suitable components need to meet specific performance criteria. However, while a component may meet certain performance criteria it may be at the cost of other desirable factors such as component weight, time to manufacture and cost to manufacture. For example, subtractive manufacturing or machining oversized blocks, materials or forgings until a desired final part shape is achieved may be one process. However, and in this process, the monolithic nature of the raw input material means that the final part weight is driven by the final volume of the part and density of material used.

Accordingly, it is desirable to provide low-cost, light weight components and components formed by such methods.

### BRIEF DESCRIPTION

A method of making a light weight component is provided. The method including the steps of: forming a first metallic foam core into a desired configuration; applying an external metallic shell to a discrete exterior surface of the first metallic foam core after it has been formed into the desired configuration; arranging the first metallic form core to be adjacent to a second metallic foam core also formed into a desired configuration to form a desired pre-form shape, wherein an applied external metallic shell located on a discrete surface of the second metallic foam core is adjacent to the external metallic shell applied to the discrete exterior surface of the first metallic foam core; and applying an external metallic shell to an exterior surface of the desired pre-form shape.

In addition to one or more of the features described above, or as an alternative to any of the foregoing embodiments, wherein the desired configuration is a hexagon.

In addition to one or more of the features described above, or as an alternative to any of the foregoing embodiments, wherein the desired configuration is a ring.

In addition to one or more of the features described above, or as an alternative to any of the foregoing embodiments, wherein the metal of the metallic foam core is selected from the group comprising: titanium; colbalt; aluminum; nickel; steel alloys, magnesium, copper, molybdenum, niobium, tungsten, zinc alloys, titanium aluminide, nickel aluminide and molybdenum disilicide.

In addition to one or more of the features described above, or as an alternative to any of the foregoing embodiments, wherein the metallic foam core is selected from the group comprising: an open cell structure; a closed cell structure and wherein the metallic foam core is formed into the desired configuration by a machining process selected from the group comprising: milling; grinding; electrical discharge machining (EDM); water-jet; and laser machining, wherein the desired configuration is slightly smaller than the final dimensions of the light weight component.

In addition to one or more of the features described above, or as an alternative to any of the foregoing embodiments, wherein the metallic foam core is a sheet of metallic foam and the sheet of metallic foam is formed into the desired configuration by a hot or cold forming process wherein the sheet of metallic foam is placed in die.

In addition to one or more of the features described above, or as an alternative to any of the foregoing embodiments, wherein the metallic foam core is an open cell structure and the applied external metallic shell defines a portion of a fluid conduit through the component.

In addition to one or more of the features described above, or as an alternative to any of the foregoing embodiments, wherein an inlet opening and an outlet opening are formed in the external metallic shell and the metallic foam core is an open cell structure and the applied external metallic shell defines a portion of a fluid conduit through the component via the inlet opening and the outlet opening and wherein the external metallic shell is deposited on the exterior surface of the metallic foam core via an application process selected from the group comprising: flame spray application process; plasma spray application process; cold-spray application process; electron beam physical vapor deposition (EB/PVD); chemical vapor deposition; and electroplating application process.

In addition to one or more of the features described above, or as an alternative to any of the foregoing embodiments, wherein an interim coat is deposited on the exterior surface of the metallic foam core prior to the application of the external metallic shell.

In addition to one or more of the features described above, or as an alternative to any of the foregoing embodiments, wherein the interim coat is a ceramic based thermal barrier coating.

In addition to one or more of the features described above, or as an alternative to any of the foregoing embodiments, further including the step of: heat treating the metallic foam core after the external metallic shell has been applied to the exterior surface of the metallic foam core.

In addition to one or more of the features described above, or as an alternative to any of the foregoing embodiments, further including the step of: forming additional features in the metallic foam core after the external metallic shell has been applied to the exterior surface of the metallic foam core.

In addition to one or more of the features described above, or as an alternative to any of the foregoing embodiments, wherein the additional features are formed by a drilling process.

In addition to one or more of the features described above, or as an alternative to any of the foregoing embodiments, wherein a supplemental application of the external metallic outer shell is applied to the metallic foam core after the drilling process.

In addition to one or more of the features described above, or as an alternative to any of the foregoing embodiments, wherein a thickness of the external metallic outer shell varies in order to provide localized structural rigidity to the component.

In addition to one or more of the features described above, or as an alternative to any of the foregoing embodiments, wherein the component is an axisymmetric duct.

In addition to one or more of the features described above, or as an alternative to any of the foregoing embodiments, a component formed by any of the above methods.

In yet another embodiment, a method of making a light weight component is provided. The method including the steps of: forming a first metallic foam core into a desired configuration; applying a metallic shell to a portion of an exterior surface of the first metallic foam core after it has been formed into the desired configuration; arranging the first metallic foam core to be adjacent to a second metallic foam core such that the metallic shell applied to the portion of the exterior surface of the first metallic foam core is covered by the second metallic foam core and the first metallic foam core and the second metallic foam core define a desired pre-form shape; and applying an external metallic shell to an exterior surface of the desired pre-form shape, wherein the metallic shell applied to the portion of the exterior surface of the first metallic foam core provides structural reinforcement to the component.

In addition to one or more of the features described above, or as an alternative to any of the foregoing embodiments, wherein the component is an axisymmetric duct.

In yet another embodiment, a component is provided. The component having: a pre-form shape defined by a plurality of metallic foam cores each having a desired configuration; a metallic shell applied to one of the plurality of metallic foam cores wherein the metallic shell is covered by another one of the plurality of metallic foam cores to define the pre-form shape; and an external metallic shell applied to an exterior surface of the pre-form shape.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a perspective view of an un-machined block of metallic foam;

FIG. 2 is a perspective view of a machined block of metallic foam;

FIG. 3 is a perspective view of an un-formed sheet of metallic foam;

FIG. 3A is a perspective view of the un-formed sheet of metallic foam placed in a die for forming the un-formed sheet of metallic foam;

FIG. 4 is a perspective view of a formed sheet of metallic foam;

FIG. 5 illustrates the application of an external metallic shell to the formed or machined metallic foam of FIG. 2 or 4;

FIG. 6 illustrates the formed or machined metallic foam of FIG. 2 or 4 with an applied external metallic shell;

FIG. 7 illustrates the formed or machined metallic foam of FIG. 6 with additional features formed therein;

FIG. 8 is a cross-sectional view of a portion of the formed or machined metallic foam of FIG. 6 or 7;

FIG. 8A is an enlarged cross-sectional view of a portion of the formed or machined metallic foam of FIG. 6 or 7;

FIGS. 9 and 10 are non-limiting examples of components formed by the methods of the present disclosure;

FIGS. 11-14 illustrated an alternative method for making a component according to an embodiment of the present disclosure;

FIG. 15 illustrates yet another alternative embodiment of the present disclosure;

FIG. 16 illustrates yet another alternative method for making a component according to the embodiments of the present disclosure;

FIG. 17A is a view along lines 17A-17A of FIG. 16;

FIG. 17A′ is a view along lines 17A-17A of FIG. 16 according to an alternative embodiment of the present disclosure; and

FIG. 18 is a flow chart illustrating a method of making a component according to non-limiting methods of the present disclosure.

### DETAILED DESCRIPTION

Various embodiments of the present disclosure are related to methods of making low cost, light weight components and components formed by the aforementioned methods. In particular, the present application is directed to a component having an internal foam core, which in one embodiment may be a metallic foam core or alternatively a non-metallic foam core such as a ceramic foam core or any other non-metallic foam core and an external metallic shell surrounding the metallic or non-metallic foam core and methods for making such a component.

The present disclosure is directed to a method of making a component using a combination of subtractive and additive manufacturing processes. In general, the method starts with a metallic foam core using alloy and foam density that is compatible with a specific design application. As mentioned above and in alternative embodiments, the foam core may be non-metallic. The metallic foam core is then machined or formed to a shaped pre-form for subsequent manufacturing steps. After the metallic foam core is formed to the desired shape, a metallic skin is applied to the external surface of the metallic foam core creating a light-weight, rigid structure which can have characteristics similar to existing non-metallic foam core or metallic or non-metallic honeycomb components. After the metallic skin is applied a final machining of the component may occur wherein dimensional characteristics and/or features are added to the component.

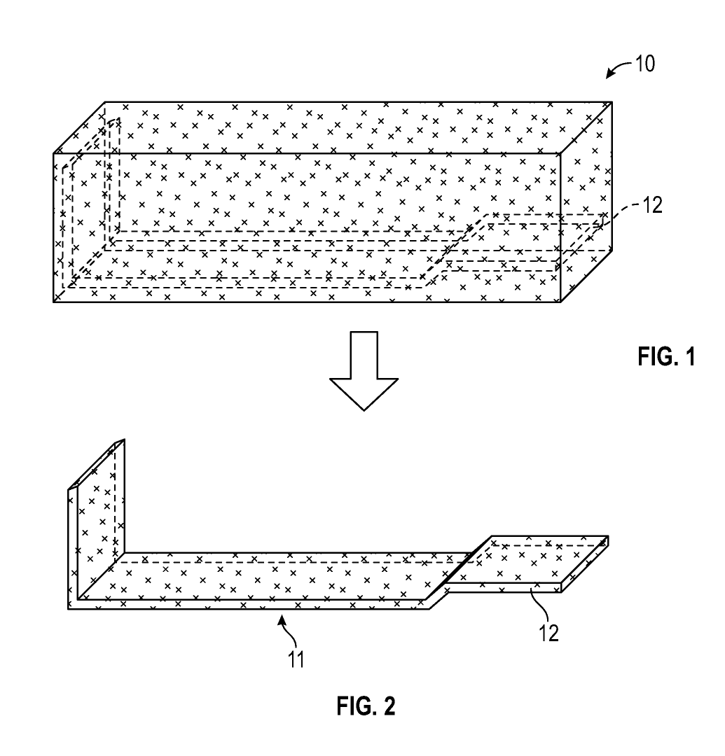

Referring now to FIG. 1, an unformed block of metallic foam 10 is illustrated. The block of metallic foam 10 may be formed from any suitable metal either commercially pure or alloy including but not limited to anyone of the following: titanium (including Ti 6-4, Ti 6-2-4-2, beta phase alloys including Beta 21s), cobalt, aluminum, nickel (including Inconel 625, Inconel 718), steel alloy, magnesium, copper, molybdenum, niobium, tungsten and zinc alloys as well as intermetallic alloys including titanium aluminide, nickel aluminide and molybdenum disilicide and equivalents thereof. In general, a metallic foam may be referred to as a cellular structure comprising a solid metal with a large volume fraction of pores. These pores may be sealed (closed-cell foam) or interconnected (open-cell foam). In one non-limiting embodiment, the porosity of the foam may be within the range of 5% to 80%. Of course, ranges of porosity greater or less than the aforementioned range are considered to be with the scope of various embodiments of the present disclosure. Selection of the porosity of the metallic foam may be dependent upon the ultimate end use of the component to be formed. For example and in some applications, it may be desirable to have a more porous foam core or a less porous foam core. The metallic foam block 10 is large enough to contain a desired part or component geometry 12 illustrated by the dashed lines 12 in FIG. 1.

In FIG. 2, the block of metallic foam 10 has been machined into a foam core 11 having the desired interim part or interim component geometry 12 via any suitable process. As used herein interim part or interim component geometry may be referred to as being slightly smaller than the final part or component geometry in order to account for the applied external metallic shell 20. In some applications, it may be desirable to form the metallic foam core to near net shape as part of the initial foam manufacturing process. Examples of machining processes include but are not limited to milling, grinding, electrical discharge machining (EDM), water-jet machining, laser machining, combinations thereof or any other process capable of machining the block 10 into the metallic foam core 11 having the component geometry 12.

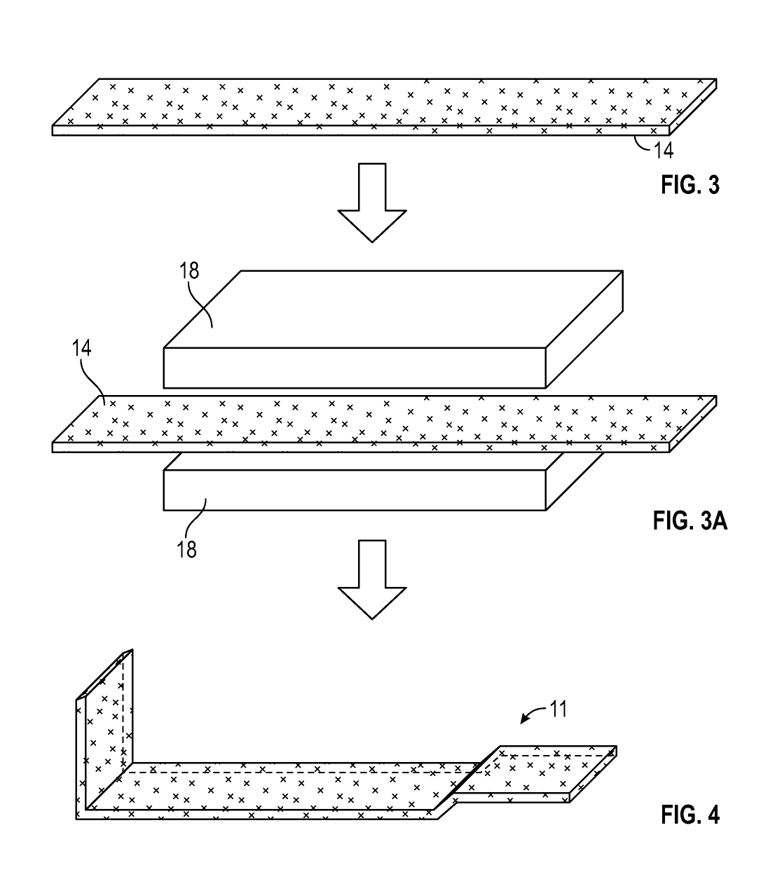

Alternatively and as illustrated in FIGS. 3, 3A and 4, a sheet of metallic foam 14 may be provided. In this alternative process, the sheet of metallic foam 14 is formed into the foam core 11 having the desired part or component geometry 12 via a hot or cold forming process wherein the sheet of metallic foam 14 is placed in a die 16. The die 16 may include a pair of complementary halves 18 configured to form the desired part or component geometry 12. In alternative embodiments, the die 16 may have more than one pair of elements or die halves 18.

The formed component or metallic core 11 is illustrated in FIG. 4. The formed sheet of metallic foam may be further shaped to a final configuration using the aforementioned machining processes such as milling, electrical discharge machining (EDM), water-jet machining, laser machining, combinations thereof or any other process capable of machining the formed sheet of metallic foam.

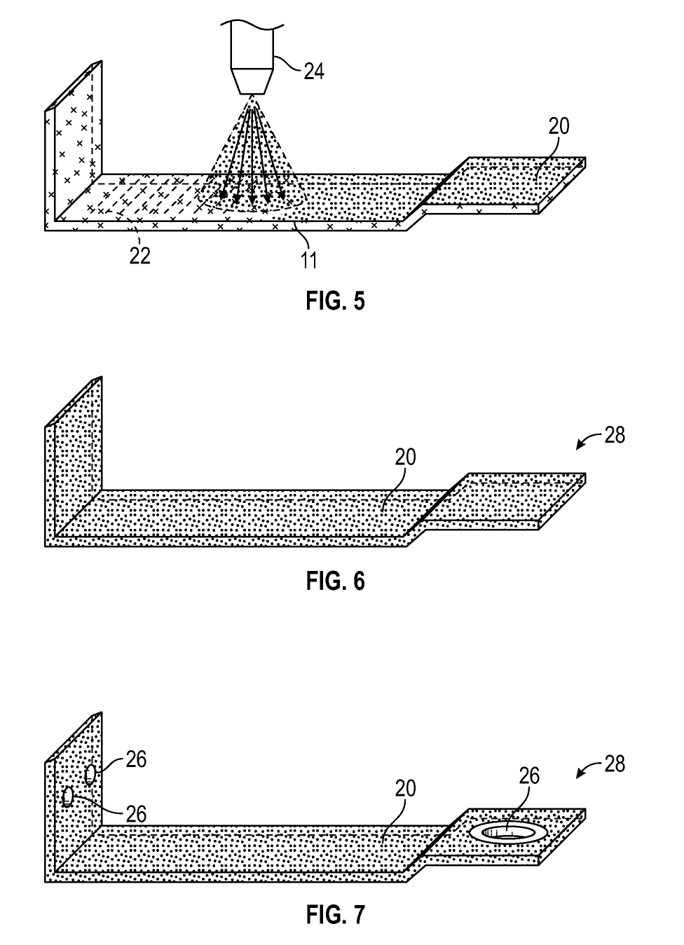

Referring now to at least FIG. 5, the formed metallic foam core 11 from any of the aforementioned processes (machining, forming or combinations thereof) depicted in at least FIGS. 1-4, has an external metallic shell 20 deposited on the exterior surface of the formed metallic foam core 11. In one embodiment, the external metallic shell 20 is deposited about the entire exterior surface of the formed metallic foam core 11. Alternatively, discrete areas of the formed metallic foam core may be masked such that the external metallic shell 20 is prohibited from covering certain areas. The external metallic shell 20 may also be referred to as an outer reinforcing metallic skin 20. Accordingly, the metallic foam pre-form or core 11 is used as a base for application of the external metallic shell 20. Depending on the initial foam cell size and material being deposited as well as the deposition method, it may be permissible to have an interim coat or applique to form a non-porous intermediate layer for metallic deposition. In this embodiment, the interim coat is first applied and then the external metallic shell 20 is applied to the metallic foam pre-form or core 11. In FIG. 5, the interim coat is illustrated by the dashed lines 22. The external metallic shell 20 is a metallic material chemically and metalurgically compatible with that of the metallic foam and the external metallic outer shell 20 may be applied via any suitable methods including but not limited to the following application processes: flame spray application; plasma spray application; cold-spray application; electron beam physical vapor deposition (EB/PVD), chemical vapor deposition (CVD) electroplating, additive manufacturing (including but not limited to electron beam melt, direct metal later sintering, free-form laser deposition, etc.) or any other suitable means. The external metallic outer skin can be made of any of the same alloys listed in the core section which includes but is not limited to titanium (including Ti 6-4, Ti 6-2-4-2, beta phase alloys including Beta 21s), cobalt, aluminum, nickel (including Inconel 625, Inconel 718), steel alloy, magnesium, copper, molybdenum, niobium, tungsten and zinc alloys as well as intermetallic alloys including titanium aluminide, nickel aluminide and molybdenum disilicide and equivalents thereof. The material used in the external metallic outer skin may be the same or may be different than that used in the foam core depending on the metallurgical compatibility of the outer skin to the foam core. In addition and in some instances when a different alloys is used for the external skin 20 as opposed to that used for the foam core, one or more intermediate alloys may be used as interim coat or coats 22 covering portions or all of the part to bridge the compatibility of the core alloy 11 and the outermost skin alloy 20.

Other non-metallic materials may be deposited in place of or in addition to the metallic coatings, these coatings may include ceramic based thermal barrier coatings.

In FIG. 5, a nozzle 24 is illustrated and in one embodiment, the nozzle 24 may be used in conjunction with a plasma spray application process. Once the external metallic outer shell 20 is applied to the exterior surface of the metallic foam pre-form or core 11, this part, as illustrated in FIG. 6, is inspected for surface coverage and may be further subjected to a heat treating step in order to relieve residuals stresses imparted by manufacturing and outer skin deposition processes and/or to provide desired final material properties. In applications where the foam core is an open cell structure, the outer skin may be perforated with a plurality of venting holes to allow for internal air to escape from the part as it is heated during the heat treating step. In one embodiment, the venting holes may be sealed after the heat treating step and in other embodiments, the venting holes may be subsequently sealed after the heat treating step.

At the next step, additional features 26 are introduced to the coated metallic foam pre-form or core 11 in order to form the desired part or component 28. These additional features may be added by any suitable process such as milling, spot-face drilling, counter-bore drilling, conventional drilling, etc. In FIG. 7, the features 26 are illustrated as openings, of course, any other configurations are considered to be within the scope of various embodiments of the present disclosure. Still further and in the event that the drilling process removes some of the external metallic outer shell 20 and the metallic foam is exposed, a supplemental application process of the external metallic outer shell 20 may be employed to cover the exposed metallic foam. In yet another embodiment, the part 28 may not require any additional features 26 to be added. In one non-limiting embodiment, the component 28 may comprise the formed metallic core 11, an applied external metallic shell 20 and if applicable feature 26 as well as an intermediary layer 22 located between an external surface of the formed metallic core 11 and the applied external metallic shell 20.

Since the external metallic outer shell 20 is applied via a process wherein the localized thickness of the external metallic outer shell 20 may vary with respect to other locations, the thickness of the external metallic outer shell 20 on the exterior of the part may be tailored in thickness, pattern and orientation to provide preferential strength and thus the part or component 28 may have localized structural features such as ribs or gussets, which are provided by the applied external metallic outer shell 20.

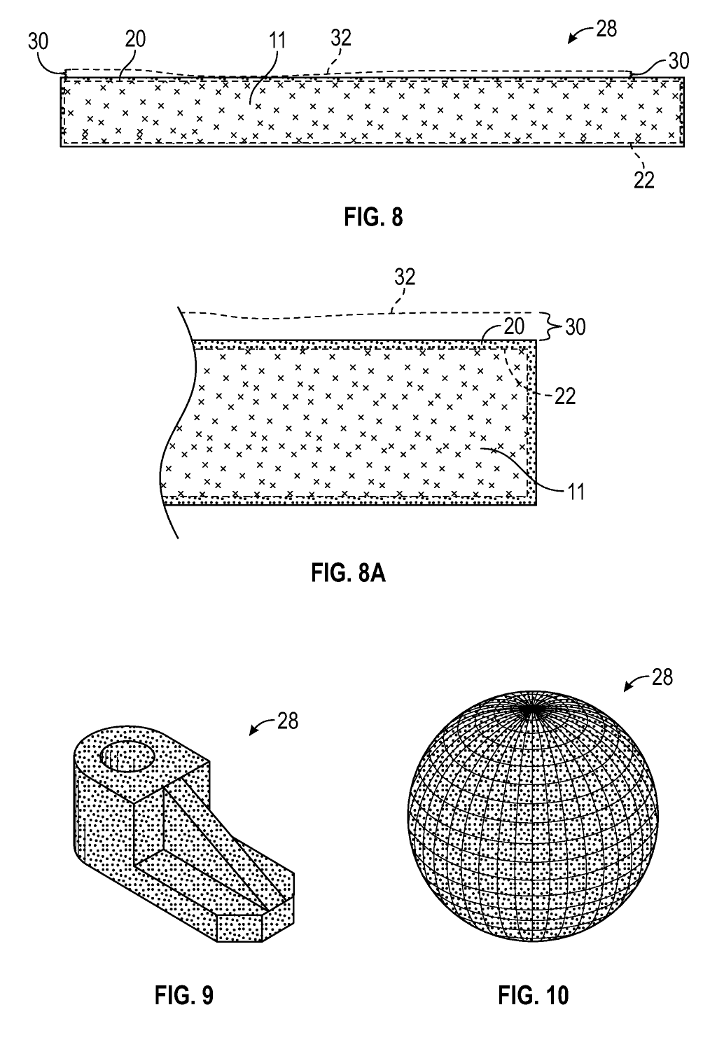

For example and referring at least to the cross-sectional view of FIGS. 8 and 8A, a thickness 30 of the external metallic outer shell 20 may vary. In FIG. 8, the dashed line 32 is provided to illustrate the varying thickness of the external metallic outer shell 20 that surrounds the internal metallic foam core 11. Also shown in FIGS. 8 and 8A is the intermediary layer 22, which may or may not be applied prior to the application of the external metallic outer shell 20.

In yet another implementation and for parts designed to be capable of bending in certain areas over others, the applied metallic skin on the external surface of the formed part in some applications places the load carrying material away from a neutral axis of the part for high structural efficiency.

In accordance with various embodiments of the present disclosure, machining or forming of the metallic foam core 11 can be done very quickly and at lower expense than machining a solid block of material. This will result in a significant reduction in raw material waste vs. machining processes applied to solid blocks of material. In addition, the metallic deposition on the outside of foam core may be tailored in thickness to provide preferential strength.

FIGS. 9 and 10 illustrate non-limiting examples of a part or component 28 formed by the various methods of the present disclosure. Some additional non-limiting examples of contemplated components or parts include brackets, housings, ducts, liner assemblies, (commercial engine tailcones, nozzles, etc). In one non-limiting embodiment, the part or component 28 may be an aviation component. In another embodiment, the component may be used in any application where the component weight and cost are key design constraints.

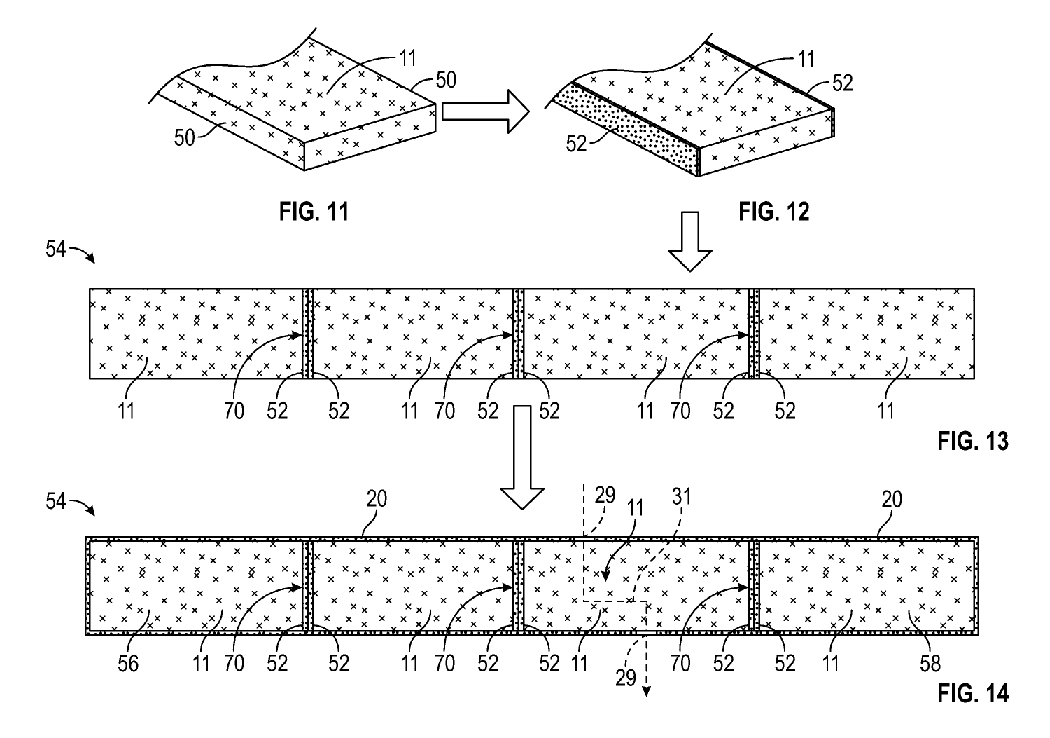

Referring now to FIGS. 11-14, an alternative embodiment of the present disclosure is illustrated. In this embodiment, the metallic foam core or metallic foam core segment 11 has the external metallic outer shell applied to selective exterior segments 50 of the metallic foam core or segment 11. In this embodiment, the selective exterior surface segments 50 of the metallic foam core or segment 11 may be lateral exterior walls of the metallic foam core or segment 11. In this embodiment, the applied external metallic outer shell applied to the exterior surface segments 50 may be referred to as a structural member or members 52, which are formed from anyone of the aforementioned metallic materials used for the external metallic outer shell 20. These structural members 52 may be applied via anyone of the aforementioned application processes discussed above. Once the structural members 52 are applied to the desired surface segments 50, the foam core or segment 11 with its structural members 52 is arranged with at least one or a plurality of foam cores or foam core segments 11 each having structural members 52 previously applied thereto. As illustrated in FIG. 13, some of the foam cores or foam core segments 11 have their respective structural members 52 adjacent to each other when they are arranged into a desired pre-form shape 54 illustrated in at least FIGS. 13 and 14. In addition and as illustrated in at least FIGS. 13 and 14, the structural members 52 are located such that they are positioned internally within the desired pre-form shape 54. Accordingly, these structural members 52 are located such that they provide structural support to the desired pre-form shape 54.

Also illustrated in FIG. 13 is that the foam cores or foam core segments 11 located on the ends of the desired pre-form shape 54 only have structural members 52 applied to a surface that will be abutted adjacent to another structural member of another adjacent foam core or foam core segment 11. These cores are identified as cores 56 and 58. Of course and in an alternative embodiment, the exterior walls or surfaces of the cores 56 and 58 may also have a structural member applied thereto. In addition and as the desired shape of the component 28 varies some of the metallic foam core segments may not have any structural member (e.g., metallic shell) applied thereto prior to the application of the external metallic shell 20.

As previously discussed, the metallic foam core 11 may be pre-formed by anyone of the aforementioned machining or forming processes or in this embodiment, the metallic foam core 11 may simply be pre-formed in its desired shape. In other words, the desired shape of the metallic foam core 11 may be a byproduct of the process used to initially make the metallic foam core 11.

Once the desired pre-form shape 54 is defined the outer reinforcing metallic skin 20 is applied to the entire exterior surface of the pre-form shape 54 using the application processes illustrated in at least FIG. 5. Accordingly and in this embodiment, the formed component 28 not only has a metallic outer reinforcing skin 20 but it also has internal reinforcing metallic ribs 70 formed by the structural members 52. In addition and as mentioned in the previous embodiments, an interim coat or applique may be applied to form a non-porous intermediate layer for the metallic deposition. Still further and as mentioned above, features 26 may be formed in the part or component 28 and if applicable an additional step of metallic deposition may occur after the formation of features 26.

In yet another alternative embodiment and as illustrated by the dashed lines in FIG. 14, features 26 may be openings 29 formed in opposite sides of the metallic outer reinforcing skin 20 of a particular foam core segment 11 and the internal reinforcing ribs 70 may act as barriers and thus a fluid path 31 through the open cell configuration of the foam core segment is provided.

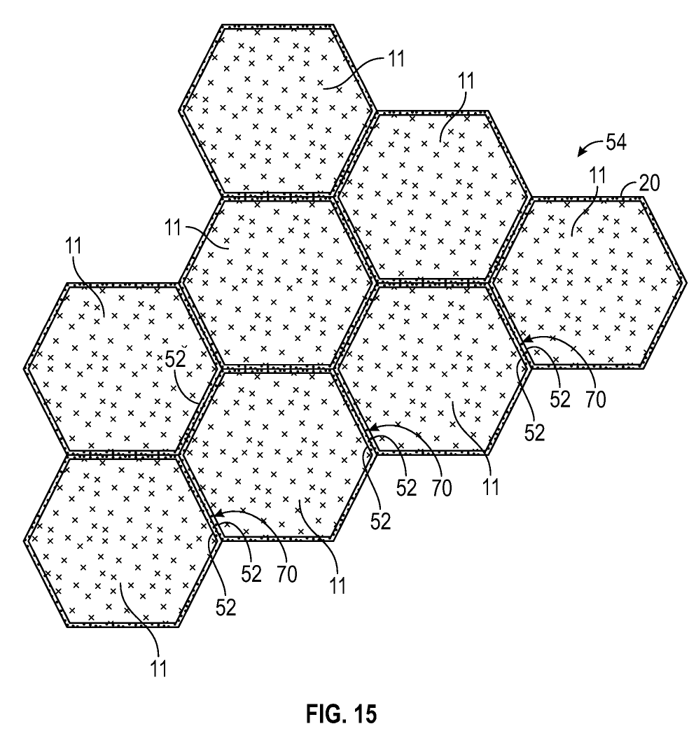

Referring now to FIG. 15, yet another alternative embodiment of the present disclosure is illustrated. Here each of the metallic foam cores 11 are configured as discrete cells wherein the internally facing lateral walls are each provided with structural members 52 as discussed above. Accordingly, a plurality of internal reinforcing metallic ribs 70 are formed by pairs of structural members 52 being adjacent to each other. Alternatively, only one of the cores may be configured with the structural member 52 and thus, the rib or ribs 70 may be formed from a single structural member 52. In this embodiment, each of the metallic foam cores 11 are configured to have a hexagon shape. Of course, numerous other shapes are considered to be within the scope of various embodiments of the present disclosure.

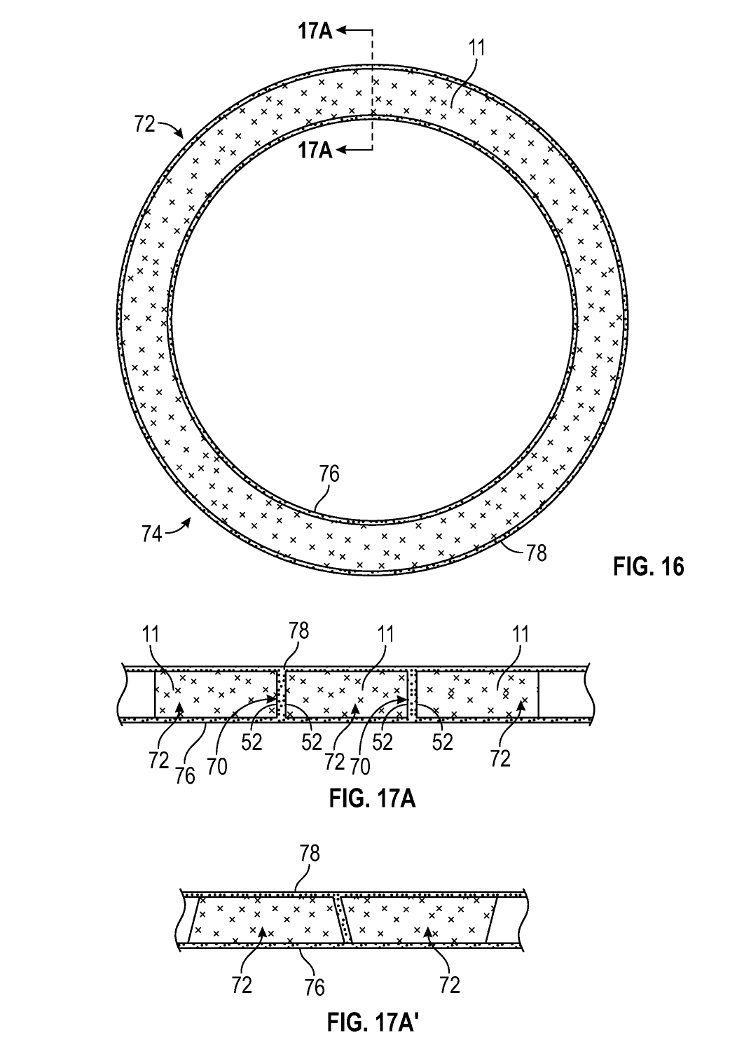

Referring now to FIGS. 16, 17A and 17A′, yet another alternative embodiment of the present disclosure is illustrated. Here each of the metallic foam cores 11 are configured as pre-formed metallic foam ring segments 72 wherein the internally facing lateral walls of the ring segments 72 are each provided with structural members 52 as discussed above. Accordingly, a plurality of internal reinforcing metallic ribs 70 formed by pairs of structural members 52 arranged to be adjacent to each other. Alternatively, only one of the ring segments 72 may be configured with the structural member 52 and thus, the rib or ribs 70 may be formed from a single structural member 52. In this embodiment, the plurality of ring segments 72 are secured to each other to form an axisymmetric duct 74 and the applied outer reinforcing skin provides an inner outer metallic skin 76 and an outer metallic skin 78.

Referring to the view of FIG. 17A, the pre-formed metallic foam ring segments 72 are illustrated along with the internal reinforcing metallic ribs 70 formed by the structural members 52. Referring to the view of FIG. 17A′, an alternative embodiment, is illustrated. In this embodiment, the pre-formed metallic foam ring segments 72 have angularly configured exterior surfaces such that the internally reinforcing metallic ribs 70 formed by the structural members 52 are angularly arranged with respect to the inner outer metallic skin 76 and the outer metallic skin 78 as opposed to the perpendicular arrangement illustrated in FIG. 17A. Of course, numerous other angular configurations are contemplated to be within the scope of various embodiments of the present disclosure.

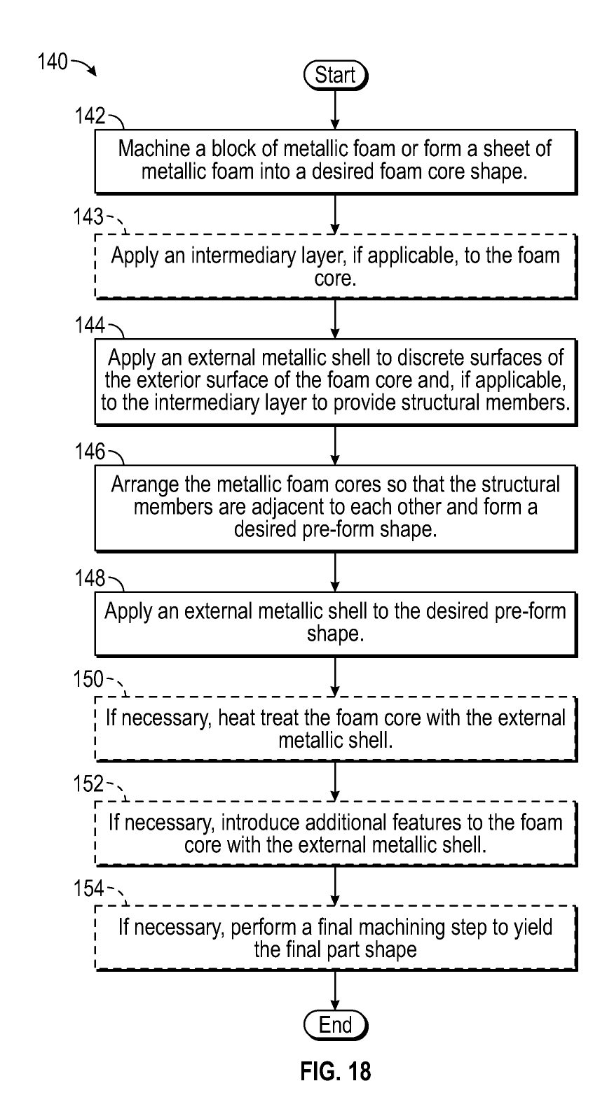

Referring now to FIG. 18, a flow chart 140 illustrating a method for forming a part or component 28 in accordance with various embodiments of the present disclosure is illustrated. At a first step 142, an unformed block of metallic foam 10 is machined to a foam core 11. As mentioned above non-limiting machining processes include milling, electrical discharge machining (EDM), water-jet machining, laser machining, combinations thereof or any other process capable of machining the block 10 into the metallic foam core 11 having desired geometry. Alternatively and at the first step 142, a sheet of metallic foam 14 may be provided and the sheet of metallic foam 14 is formed into the foam core 11 having the desired part or component geometry via a hot or cold forming process wherein the sheet of metallic foam 14 is placed into a die 16. The die 16 may include a pair of complementary halves 18 configured to form the desired part or component geometry 12. The formed sheet of metallic foam may be further shaped to a final configuration using the aforementioned machining processes.

Thereafter and at step 144, the formed component or metallic core 11 from any of the aforementioned processes (machining, forming or combinations thereof) has structural members 52 applied to surface segments 50 of the foam core or segment 11.

Thereafter and at step 146, the metallic core 11 with its structural members 52 is arranged with at least one other core 11 or a plurality of cores 11 such that the structural members 52 are adjacent to each other and a desired pre-form shape 54 is provided.

Thereafter and at step 148, the external metallic shell 20 is deposited on the exterior surface of the pre-formed shape 54. As a precursor to steps 144 and 148, an interim coat or applique may be applied to the foam core 11 prior to the application of the structural members 52 and the external metallic shell 20. This is illustrated as alternative step 143, which is illustrated in dashed lines. As mentioned above, the structural members 52 and the external metallic outer shell 20 may be applied via any one of the aforementioned processes including but not limited to: flame spray application; plasma spray application; cold-spray application; electron beam physical vapor deposition, (EB/PVD), chemical vapor deposition (CVD), electroplating, additive manufacturing (including but not limited to electron beam melt, etc.) or any other suitable means.

Once the external metallic outer shell 20 is applied to the exterior surface of the pre-formed shape 54, this part, may be further subjected to a heat treating step 150, which is illustrated in dashed lines as this step may not be required in all processes.

At step 152, additional features, if required, are introduced to the coated metallic foam pre-formed shape 54 in order to form the desired part or component 28. These additional features may be added by any suitable process such as milling, spot-face drilling, counter-bore drilling, conventional drilling, etc. Still further and in the event that the drilling process removes some of the external metallic outer shell 20 and the metallic foam is exposed, a supplemental application process of the external metallic outer shell 20 may be employed to cover the exposed metallic foam. In yet another embodiment, the part 28 may not require any additional features 26 to be added. In addition and as illustrated by the dashed lines in FIG. 18, an alternative step 154 may be provided wherein a final machining step of any key attachment, interface or functionally critical surfaces of the part or component occurs after step 152. This would yield the final part shape.

As discussed herein various methods for producing lightweight, low cost components and/or parts are provided. Still further components and/or parts formed by the various methods are also provided.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of making a light weight component, comprising:
forming a first metallic foam core into a desired configuration;
applying an external metallic shell to a discrete exterior surface of the first metallic foam core after it has been formed into the desired configuration;
arranging the first metallic form core to be adjacent to a second metallic foam core also formed into a desired configuration to form a desired pre-form shape, wherein an applied external metallic shell located on a discrete surface of the second metallic foam core is adjacent to the external metallic shell applied to the discrete exterior surface of the first metallic foam core; and
applying an external metallic shell to an exterior surface of the desired pre-form shape.

2. The method as in claim 1, wherein the desired configuration is a hexagon.

3. The method as in claim 1, wherein the desired configuration is a ring.

4. The method as in claim 1, wherein the metal of the metallic foam core is selected from the group comprising: titanium; colbalt; aluminum; nickel; steel alloys, magnesium, copper, molybdenum, niobium, tungsten, zinc alloys, titanium aluminide, nickel aluminide and molybdenum disilicide.

5. The method as in claim 1, wherein the metallic foam core is selected from the group comprising: an open cell structure; a closed cell structure and wherein the metallic foam core is formed into the desired configuration by a machining process selected from the group comprising: milling; grinding; electrical discharge machining (EDM); water-jet; and laser machining, wherein the desired configuration is slightly smaller than the final dimensions of the light weight component.

6. The method as in claim 1, wherein the metallic foam core is a sheet of metallic foam and the sheet of metallic foam is formed into the desired configuration by a hot or cold forming process wherein the sheet of metallic foam is placed in die.

7. The method as in claim 1, wherein the metallic foam core is an open cell structure and the applied external metallic shell defines a portion of a fluid conduit through the component.

8. The method as in claim 1, wherein an inlet opening and an outlet opening are formed in the external metallic shell and the metallic foam core is an open cell structure and the applied external metallic shell defines a portion of a fluid conduit through the component via the inlet opening and the outlet opening and wherein the external metallic shell is deposited on the exterior surface of the metallic foam core via an application process selected from the group comprising: flame spray application process; plasma spray application process; cold-spray application process; electron beam physical vapor deposition (EB/PVD); chemical vapor deposition; and electroplating application process.

9. The method as in claim 1, wherein an interim coat is deposited on the exterior surface of the metallic foam core prior to the application of the external metallic shell.

10. The method as in claim 9, wherein the interim coat is a ceramic based thermal barrier coating.

11. The method as in claim 1, further comprising the step of: heat treating the metallic foam core after the external metallic shell has been applied to the exterior surface of the metallic foam core.

12. The method as in claim 1, further comprising the step of: forming additional features in the metallic foam core after the external metallic shell has been applied to the exterior surface of the metallic foam core.

13. The method as in claim 12, wherein the additional features are formed by a drilling process.

14. The method as in claim 13, wherein a supplemental application of the external metallic outer shell is applied to the metallic foam core after the drilling process.

15. The method as in claim 1, wherein a thickness of the external metallic outer shell varies in order to provide localized structural rigidity to the component.

16. The method as in claim 1, wherein the component is an axisymmetric duct.

17. A component formed by the method of claim 1.

18. A method of making a light weight component, comprising:
forming a first metallic foam core into a desired configuration;
applying a metallic shell to a portion of an exterior surface of the first metallic foam core after it has been formed into the desired configuration;
arranging the first metallic foam core to be adjacent to a second metallic foam core such that the metallic shell applied to the portion of the exterior surface of the first metallic foam core is covered by the second metallic foam core and the first metallic foam core and the second metallic foam core define a desired pre-form shape; and
applying an external metallic shell to an exterior surface of the desired pre-form shape, wherein the metallic shell applied to the portion of the exterior surface of the first metallic foam core provides structural reinforcement to the component.

19. The method as in claim 18, wherein the component is an axisymmetric duct.

20. A component, comprising:
a pre-form shape defined by a plurality of metallic foam cores each having a desired configuration;
a metallic shell applied to one of the plurality of metallic foam cores wherein the metallic shell is covered by another one of the plurality of metallic foam cores to define the pre-form shape; and
an external metallic shell applied to an exterior surface of the pre-form shape.
